(19) United States
(12) Patent Application Publication
(10) Pub. No.: US 2021/0224413 A1
(43) Pub. Date: Jul. 22, 2021

(54) VEHICLE ENTERPRISE FLEET MANAGEMENT SYSTEM AND METHOD

(71) Applicant: YOPPWORKS INC., Kanata (CA)

(72) Inventors: Jack Gulas, Kanata (CA); Paul Mumby, Kanata (CA)

(21) Appl. No.: 16/763,936

(22) PCT Filed: Nov. 13, 2018
(86) PCT No.: PCT/CA2018/051433

§ 371 Date: May 13, 2020

Related U.S. Application Data
(60) Provisional application No. 62/585,295, filed on Nov. 13, 2017.

(51) Int. Cl. G06F 21/62; B64C 39/02; H04W 4/40; G06F 16/2458; G06F 21/60

(52) U.S. Cl. CPC G06F 21/6227; B64C 39/024; G06F 21/604; G06F 21/6245; G06F 16/2471; H04W 4/40

(57) ABSTRACT

The present disclosure relates to systems and methods for vehicle fleet management. The systems and methods disclosed herein allow for a back-end data platform to manage data collected via unmanned vehicles/robots or industrial vehicle, as well as one or more front-end applications to facilitate capturing, uploading, and reporting of data from the vehicles. Methods and systems for partitioning data received from one or more vehicles are disclosed that, among other things, allow customers to retain any sensitive data while also making any non-sensitive data publicly available. Methods and systems for responding to a query that request vehicles are disclosed that, among other things, allow reports and other data analytics tools to be generated comprising non-sensitive data from a plurality of customers/vehicles, as well as sensitive data for particular vehicles when the user has appropriate authorization to access such sensitive data.

### CROSS-REFERENCE TO RELATED APPLICATIONS

The present disclosure is non-provisional application of U.S. Provisional Application No. 62/585,295 filed Nov. 13, 2017, the entirety of which is hereby incorporated by reference for all purposes.

### TECHNICAL FIELD

The present disclosure relates to systems and methods for managing a fleet of unmanned vehicles or industrial vehicles, and in particular to the management and analysis of data generated by one or more unmanned vehicles or industrial machinery.

### BACKGROUND

Unmanned vehicles/robots are becoming increasingly popular, both for recreational, professional and military applications, such as for example unmanned aerial vehicles (UAVs) and autonomous automobiles. The data generated by such vehicles is invaluable for guiding decision-making, such as what models of unmanned vehicles may be best-suited for operational requirements of a desired activity, performance, maintenance planning, flight planning etc. In addition industrial vehicles or construction machinery, which may or may not be autonomous, are becoming more sophisticated and can collect and generate more data on their performance and operation.

From a manufacturer perspective for the data to be useful, a large population size of data is required. However, certain vehicle owners/users may have data that is deemed to be sensitive and which they do not wish to share outside of their organization. Similarly an operator may have vehicles from different manufacturers and wish to correlate data across vehicles which present data formatting challenges.

Accordingly, systems and methods that enable additional, alternative, and/or improved ways to manage and analyze data generated by one or more unmanned vehicles and industrial vehicles remains highly desirable.

### SUMMARY

In accordance with an aspect of the present invention there is provided a method of partitioning data received from one or more vehicles, comprising: receiving vehicle raw data from an vehicle of the one or more vehicles, the vehicle raw data comprising both sensitive and non-sensitive data; converting the vehicle raw data into a plurality of universal data elements, each data element indicating the vehicle from which the raw data was received, a sensor reading of the vehicle, and a time that the sensor reading occurred; determining, from a data privacy map established by an owner of the vehicle, which of the universal data elements are sensitive data elements and which of the universal data elements are non-sensitive data elements; transmitting the non-sensitive data elements to an external device; and storing the sensitive data elements locally.

In accordance with an aspect of the present invention there is provided a method of responding to a query requesting vehicle data, comprising: receiving, from a user, the query requesting vehicle data, the query having a security level associated therewith; determining, based on the security level associated with the query and the vehicle data requested by the query, vehicle data elements that provide the vehicle data requested and that correspond to the security level associated with the query; determining one or more nodes storing the vehicle data elements; generating a sub-query request for each of the one or more nodes, the sub-query request indicating the vehicle data elements to be retrieved at the respective node, and an indication of an output node to which the vehicle data elements should be sent to; sending the sub-query requests to each of the one or more nodes; receiving the requested vehicle data elements from the one or more nodes; and aggregating the vehicle data elements to provide a report.

In accordance with an aspect of the present invention there is provided a system for partitioning data received from one or more vehicles and responding to a query requesting vehicle data, comprising: a first server hosting a customer network; and a second server hosting a cloud-based data platform operably coupled with the first server through a data network; wherein the first server is configured to: receive vehicle raw data from an vehicle of the one or more vehicles that is operably coupled with the customer network, the vehicle raw data comprising both sensitive and non-sensitive data; convert the vehicle raw data into a plurality of universal data elements, each data element indicating the vehicle from which the raw data was received, a sensor reading of the vehicle, and a time that the sensor reading occurred; determine, from a data privacy map established by an owner of the vehicle, which of the universal data elements are sensitive data elements and which of the universal data elements are non-sensitive data elements; transmit the non-sensitive data elements to the second server through the data network; and store the sensitive data elements locally.

### BRIEF DESCRIPTION OF THE DRAWINGS

Further features and advantages of the present disclosure will become apparent from the following detailed description, taken in combination with the appended drawings, in which:

FIG. 1 shows a representation of a system for managing a fleet of unmanned vehicles and industrial vehicles;

FIG. 2 shows a representation of a system used for generating reports for a fleet of unmanned vehicles and industrial vehicles;

FIG. 3 shows a method for partitioning data received from one or more unmanned vehicles and industrial vehicles;

FIG. 4 shows a diagram representing the partitioning of data received from an unmanned vehicle and industrial vehicles;

FIG. 5 shows a data storage structure for storing unmanned vehicle data and industrial vehicles;

FIG. 6 shows a method for responding to a query that requests unmanned vehicle data and industrial vehicles;

FIG. 7 shows a diagram representing the generation of a report in response to a query; and

FIG. 8 shows a diagram representing the aggregation of unmanned vehicle data and industrial vehicles.

It will be noted that throughout the appended drawings, like features are identified by like reference numerals.

### DETAILED DESCRIPTION

The present disclosure provides systems and methods for unmanned vehicle fleet management, such as drones, UAVs (Unmanned Aerial Vehicles), ROVs (Remotely Operated Vehicles), autonomous vehicles and industrial vehicles etc.

The systems and methods disclosed herein allow for a back-end data platform to manage data collected via unmanned vehicles/robots and can also be applicable to industrial vehicles, as well as one or more front-end applications to facilitate capturing of data from unmanned vehicles and industrial vehicles in the field, uploading of the data to the back-end platform, visualization and reporting of the data, and providing alerts and other useful information to guide decisions based on the data. The back-end data platform components may collectively offer a web or other service platform that can be accessed by the one or more front-end applications respectively providing user interfaces. One of the front-end applications may be a web application. Another front-end application may be associated with a type of mobile device. Application programming interfaces may be publicly available to allow third party integration as well. For industrial vehicles data may be collected for vehicles in a particular location or at multiple locations, for example a mine or construction site.

The systems and methods disclosed herein allow for the ability to handle data for any type of autonomous robot or drone including land, sea, and air, as well as the ability to handle data for individual robots, components thereof, and/or the aggregate of a large fleet of robots or industrial vehicles. Access to such a large and diverse set of data allows for the determination of emerging trends and complex predictive analytics, while also satisfying securing concerns of large enterprises, government, and military uses, for example.

Non-sensitive or unrestricted data may be uploaded to a data platform, and accessed/shared with other users. Any sensitive data is always maintained securely on the customer network and is not uploaded to the data platform or accessed/shared with other users external to the customer network. Secure hosting services may also be provided, which host a dedicated data node for a customer that does not want to operate their own customer network, but also does not want certain data mingling with the non-secure cloud data.

The system disclosed herein is built around two primary domains, with two primary focuses from a user interface perspective.

A Core Data Domain focuses on the data modelling, storage, distribution, and querying of robot generated data in a granular fashion, while supporting a hybrid cloud approach that enables customers and users to protect a sub-set of their data. A series of components and micro-services may be implemented specifically for dealing with the core data. The Core Data Domain comprises a Universal Data Model (UDM) that provides categorized and distributed columnar key/value storage of data, a granular breakdown of robot and/or sensor data, the characteristics of a key, and the characteristics of a value (including complex value types), and extensibility). The Core Data Domain further comprises Data Repositories, Data Classification (e.g. sensitive, non-sensitive data), and Data Repository Lookup (the location of certain data for a given customer or user). The Core Data Domain further comprises Raw File Ingestion, including decryption and decoding of data, and extraction of metadata. The Core Data Domain still further comprises Data Mapping and Storage, which converts raw data into UDM data and decides where to store it. Data Packets may be used for an efficient serialization of data, for shipping between repositories, and storage. The Core Data Domain also supports a mechanism to query the data stored in the UDM and distributed across multiple repositories. Security is implemented to prevent unauthorized access and/or modifications to various elements of the data. Specific types of objects within the Core Data Domain include vehicle vendors, robot vendors, robot models (models have a schema), components (batteries, motors, props, etc.), and missions (e.g. a collection of data objects, for a given combination of robot and components.

A Fleet Operations Domain focuses on the operations of robots, or fleets of robots, or vehicles as well as the operations of a business focusing on robots, or fleets of robots. A series of components and micro-services may be implemented specifically for providing fleet operations. The Fleet Operations Domain may provide user management, document management (maintenance records, official certifications, registration/licensing documents, insurance documents, etc.), pilots (stats, permissions, training, certifications, etc.), robots (details, serial numbers, purchase info., maintenance history, warranty information), parts (batteries, props, motors, etc.), assignment (asset management), business operation tools (customers, jobs, contracts, etc.), compliance reporting, and incidents (tracking, investigation, post-mortem analysis, etc.).

A user interface providing Fleet Operations and Data Acquisition may be implemented. The user interface includes end-user functionality and features that provide: Sign-In/User Management, Management of Pilots, Management of Drones, Management of Parts, Management of Clients/Jobs, Management of Documents, keeping notes on all of the above (as well as general notes), Management of Maintenance Logs, Asset Tracking, Assignment of Equipment/Pilot to a Job, Assignment of Equipment to a Pilot, return-by dates, check-out of equipment by pilots, or driver, (if enabled), manual upload of log files, and possible auto-detection of files based on model choice.

A user interface providing Data Reporting and Analytics may also be implemented. The user interface allows a user to perform analytics and visualization of data coming from the Core Data Domain, and displaying the data in a way that is relevant to the Fleet Operations Domain. From this perspective, there is end-user functionality and features that provide:
View Charts/Graphs, Geospatial, and trends of data from:
   Individual Drones/UVs
   Individual Components
   Individual Pilots
   Individual Flights
   Aggregated Drones/Components by:
      Flight
      Pilot
      Job
      Customer
      Drone/Component
      Model
      etc.
   Aggregated data from global statistics/trends to give greater value/insights
Custom Derived data based on our own analysis
Allow users to build “Reports”
Reports can be viewed manually, or automatically run at intervals
Notifications and Alerts based on triggers

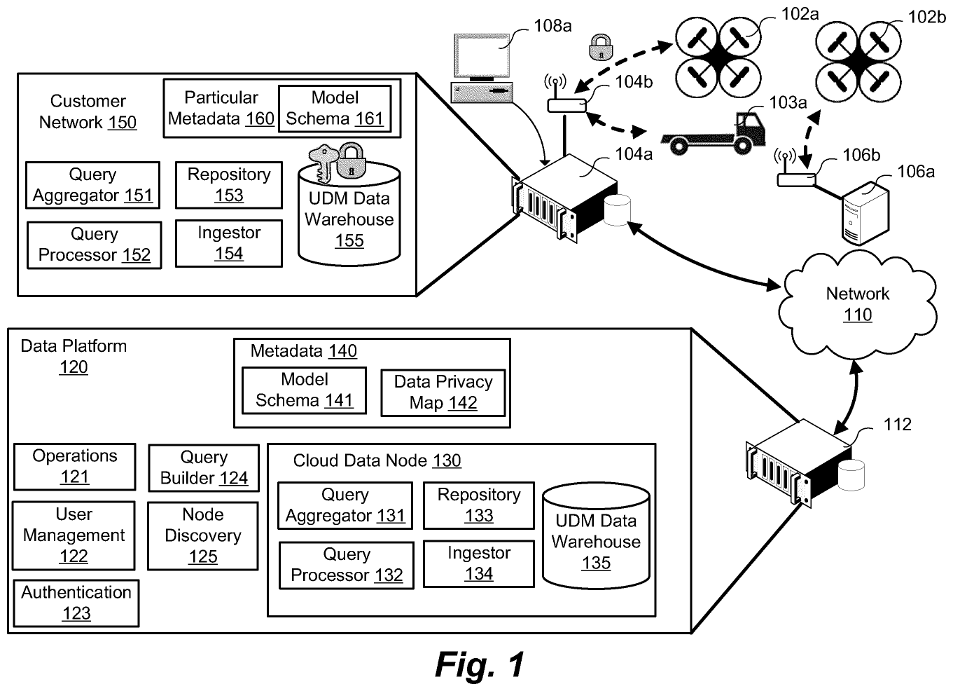

Embodiments are described below, by way of example only, with reference to FIGS. 1-8.

FIG. 1 shows a representation of a system for managing a fleet of unmanned vehicles. Data from one or more unmanned vehicles, such as drones 102a and 102b (collectively, unmanned vehicle 102), may be transmitted to server 104a of a Customer Network 150 and/or server 106a of a Global Network 110, such as the Internet. The Customer Network 150 may be restricted and may only be accessed, for example with computer 108a, where a user of the computer 108a has authorization to access the Customer Network 150. The Global Network 110 is a public network that may be accessed by anyone.

The data may be received at the servers 104a or 106a through a wireless interface such as wireless routers 104b and 106b, respectively, which are operably coupled with the servers. Data may also be sent from the servers 104a and 106b to the unmanned vehicles 102, and data may further be exchanged between the Customer Network 150 and the Global Network 110 through servers 104a and 106a. The data to/from the unmanned vehicles 102 or industrial vehicle 103 may also be transmitted/received through a direct connection (not shown). The data may be provided by a defined protocol such as for example MAVLink (Micro Air Vehicle Link) or vendor specific link protocol. As depicted in FIG. 1, the transmitted data may be encrypted (such as the data between the drone 102a and the server 104a, or vehicle 102c). The transmitted data may be encrypted for security purposes to prevent unauthorized interception and access of sensitive data. Particularly, transmitted data may be encrypted when being sent to/from the Customer Network 150, for reasoning further described herein.

A central server 112 running a Data Platform 120 can exchange data through the Global Network 110. For example, the central server may 112 send and receive data to/from the drone 102b through the server 106a, and the central server 112 may send and receive data to/from the drone 102a, or vehicle 103a through the server 104a via the Global Network 110. The Data Platform 120 is configured to store any non-sensitive and/or public data pertaining to unmanned vehicles 102 or vehicles 103. The unmanned vehicles 102 may be any type of land, sea, or air robot and may respectively or collectively belong to individual customers.

The Data Platform 120 comprises various logical elements representative of functionality that the central server 112 is configured to perform, including but not limited to: Operations 121, User Management 122, Authentication 123, Query Builder 124, and Node Discovery 125. The Data Platform further comprises a Cloud Data Node 130, which itself comprises a Query Aggregator 131, Query Processor 132, Repository 133, Ingestor 134, and UDM Data Warehouse 135. The Data Platform may also comprise Metadata 140, which comprises a Model Schema 141 and Data Privacy Map 142. The Customer Network 150 is a data node that similarly comprises a respective Query Aggregator 151, Query Processor 152, Repository 153, Ingestor 154, and UDM Data Warehouse 155. These logical elements are further described below.

The UDM (Universal Data Model) Data Warehouse 135, 155, is how all data is stored. This Data Model supports breaking each data element down into individual records of Key→Value, where Value can be a complex data type. (eg: 3 Axis Double Precision Vector, or Radial array, GPS Data, etc). Each Key may belong to any number of Categories. While the individual record is being described as a Key→Value, in fact it's a Key-Value pair, blended with a link to a given “Mission” record, a particular “Robot”, and possibly “Components”, and will be attached to a timestamp (ie: a voltage reading, might be for a Battery, from flight #192 @12:45:45.0214 PM UDT). UDM Data Elements refers to a single data point record in the UDM model. (i.e: a single sensor reading's key→value, at a specific point in time, for a specific flight/pilot/robot/component, etc.). The timestamp precision must be high, as some drones sample upwards of 2000 times per second (or more), meaning that even millisecond precision may not be sufficient.

As depicted in FIG. 1, the UDM Data Warehouse 155 within the Customer Network 150 may encrypt a subset of the stored data. As noted above, and will be further described herein, unmanned vehicle data received at the Customer Network may contain sensitive data. Encrypting and storing the received data in the UDM Data Warehouse 155 adds a further layer of security to prevent unauthorized access.

Each Robot/Vehicle Model has a Schema, which is stored as Model Schema 141, 161. This maps UDM Keys to a model of robot, by providing information that identifies, e.g., which sensors does a particular model of drone have, what data does it generate, etc. There may be more than one of a given key, and the Model Schema assigns them unique names such as Sensor0, Sensor1, etc.

The Data Privacy Map 142 is a mapping of either Keys, or Categories of Keys to either “Sensitive Data”, or “Not Sensitive”. There may also be other states such as “Obfuscate”, for example. Each customer has a Data Privacy Map applied to them.

The Data Node (e.g. Cloud Data Node 130) is a collective of the following sub-components: Ingestor, Repository, Query Processor, and Query Aggregator. The collection of these sub-components makes a stand-alone Node, which is capable of handling UDM data. A Data Node may run in the cloud (Cloud Data Node 130) or it may be a “Portable Data Node” which runs on-premises at a customer site (e.g. this collection of components is located in the Customer Network 150), in order to ingest, house, and query customer's sensitive as well as non-sensitive data.

The Ingestor 134, 154 is responsible for receiving raw files being uploaded for processing. These files can be in any format, though plugins may be required for various vendors. A given customer may have multiple Ingestors available (e.g. one in the Data Platform 120, and one on-premises in the Customer Network 150). In the event that a given customer has any sensitive data, all data uploads are redirected by Node Discovery to the On-Premise Node. The Ingestor consumes the raw files, and breaks them up into individual UDM Data Elements. Then using Node Discovery, decides how to separate the data into packets which are submitted either to the public Data Nodes, or to an on-premises Data Node.

The Repository 133, 153 is a datastore, and is made up of a read and write micro-service. The Repository handles storage and retrieval of UDM Data Elements.

The Node Discovery Component 125 is used to determine, for a given pilot/flight/customer/etc., whether or not they have sensitive data. The Node Discovery 125 is further configured to determine if the pilot/flight/customer/etc. is running a Data Node on-premises within their respective Customer Network 150, and if so, the location of the Data Node, how many data nodes exist on the Customer Network, etc. The determinations by the Node Discovery 125 help to determine how to partition data that is received by the corresponding pilot/flight/customer/etc. The Node Discovery 125 helps to route data from the client side to the appropriate Ingestor, and is also used by the Ingestors to route Data Packets into the right Repositories.

The Query Processor 132, 152, is responsible for querying UDM Data Elements from the local Data Node. The Query Processor is only responsible for fulfilling queries for which the local repository actually physically holds the data. If a query comes is received that is for data in which the local Data Node does not possess, the Query Processor 132, 152 returns an error.

The Query Builder 124 is configured to receive a higher level query for an overall set of UDM Data Elements. When a query is first received, it is not known where the data elements are located. Queries may originate in the client for querying analytics data. The Query Builder 124 uses Node Discovery 125 to determine where the subsets of the required data live. The Query Builder 124 selects an appropriate Query Aggregator to receive the aggregate data, and submits sub-queries to each Query Processor (within their respective Data Nodes). These sub-queries may include a header directing the Query Processor to return it's results to the specified Query Aggregator. The Query Builder 124 may also submit any aggregation stage query clauses to the Query Aggregator, along with the user ID associated with the new query. The Query Builder 124 may also return a response to the client, with a UID of the query, and the Query Aggregator where the client may retrieve the query results.

The Query Aggregator 131, 151 receives sub-query results from one or more Query Processors, identified with a UID for the client-side query that generated them. Once the Query Aggregator receives all the required parts of the sub-query results, any final aggregation clauses are applied. The sub-query results may, for example, be aggregated into a report in response to the query. The Query Aggregator may hold the final results for the client to request, and the client can then request the query results for a given UID directly from the Query Aggregator and the final results will be returned to the client for display/visualization. Alternatively, the query results and/or report may be pushed to the client, for example, through a user interface displayed on the computer 108a.

The Operations Component 121 comprises a cluster of micro-services, handling operational data such as: Pilots, Customers, Jobs, Missions, Documents, Notes, Assignment/Asset Tracking, etc. The functionality of the Operations Component 121 may leverage some data points from the UDM, however for the most part these services are stand-alone, and operate in a more conventional relational database management system (RDBMS) type back-end.

The Authentication Component 123 handles multi-tenant authentication of users from the client-side. This service may simply be implemented as a user login service. The Authentication Component 123 supports authorization of users of different roles. For example, some users may be pilots of UVs, while other users may be administrators. Users may also belong to more than one organization. For example a freelance pilot may belong to 3-4 different enterprises. In that case during authentication the user may be presented an option to choose which organization he is signing into.

The User Management Component 122 comprises one or more micro-services that handles activities such as: User Creation, User Deletion, Password Resets, inviting a user to an organization (e.g. enterprise admins could invite users by email to join their organization, a “Pilot” may belong to more than one organization), User Rights Management/Role Management, etc.

Some elements depicted as being part of the Data Platform 120 may instead, or in addition, be included in the Customer Network 150. For example, the Customer Network 150 shown in FIG. 1 is also depicted as comprising Particular Metadata 160, which itself comprises a Particular Model Schema 161. Having a Particular Model Schema 161 located within the Customer Network 150 may be implemented, for example, if the models of unmanned vehicles operated by the owner of Customer Network 150 are known and finite. Again, the system depicted in FIG. 1 may be implemented in various ways as would be appreciated by a person skilled in the art without departing from the scope of this disclosure.

The system depicted in FIG. 1 shows an exemplary system only, and the above logical elements are exemplary used to describe the functionality of the system. Modifications to the logical elements, including adding, combining, or removing logical elements in an implementation of the system that meets the functionality requirements of the system would be readily apparent to a person skilled in the art without departing from the scope of this disclosure. Some of the functionality requirements of the system are outlined below.

One functionality requirement is to provide a data platform configured to consume raw log files that have no “standard format”. The UDM may be created in a manner that can accommodate new data types from new vendors without re-write. Data ingested from raw logs are converted into elements that satisfy UDM. The UDM supports granular data storage (e.g. columnar), and each data value (column/field) in the data, must be able to be stored independently of each other.

The UDM may be implemented as a Key→Value Pair, with Keys established for each main data type, and values being able to support complex data types. For example:
“Accelerometer”→X,Y,Z Vector data value
“Magnetometer”→X,Y,Z Vector data value
“Gyroscope”→X,Y,Z Vector data value
“Temperature”→Single temperature value
“GPS”→Complex GPS Data type, eg:
   GPSData(Lat,Long,Altitude,Sats,Quality,Confidence)
“Radar Ranger”→Single Distance Value
“Radar Sweep”→Array of Radial Distance Values
“Visual Obstacle Avoidance”→2D Depth Map
“LIDAR”—2D Depth Map, or Spherical Array of Distance Values

The UDM may have a concept of “Derived Keys” which are calculated through some transformation of other keys. This may be represented generically, such as in an extensible API, which allows for new derived data to be easily developed. Derived Keys can similarly be identified as sensitive or non-sensitive. If a derived key includes any sensitive data for a customer, the derived key automatically becomes sensitive itself. The generation of derived key values may be a part of a scheduled job which runs on the data repository containing the derived key data. If for example a derived key contains one sensitive field, and does some calculation against a non-sensitive field, the data repository will need to query the other repo in the cloud which holds the non-sensitive field, and do the transformation as an async job.

The UDM may have a concept of a “Data Category”, which contains one or more keys. A key may belong to more than one category. For example:
Positional Data Category
   GPS Data
IMU Data Category
   Accelerometer
   Gyro
   Magnetometer
   GPS
   Visual
   LIDAR
Visual Sensors Category
   Visual
   Radar
   LIDAR
   etc.

The UDM may have a concept of a “robot model” which defines a robot master schema. The master schema defines which keys belong to a given vehicle. As noted above, a vehicle may have more than one of each key type. For each key mapping to the schema, the column is given a unique name, i.e.: Accelerometer0, Accelerometer1, Gyroscope0, Gyroscope1, etc.

Another requirement of the UDM is for it to be extensible. Plugins to support new value types may be implemented.

The system is configured for data sensitivity to be decided on a per-customer basis. Data can be flagged as either sensitive or not-sensitive. Data can be flagged on either a category, or individual key.

If a customer wishes to store data on their own network, for example to store sensitive data, the customer is able to have their own data storage repository that runs on-premises, including the raw-log ingestor component.

A system requirement is also to provide a mechanism for the discovery of data repositories, and if a customer has any sensitive data, then all logs are sent to an on-premises ingestor, rather than to the cloud. The data repository of which the data should be sent to may be determined at the time of data collection on a per-key value when ingested if it's stored in on-premises repository or in a cloud. The Keys/Values are bundled into packets, and shuttled to the appropriate storage repositories during ingestion.

The data repository is a component which stores a given subset of key/value pairs and is a long-term datastore. The data repository comprises a back-end storage platform (such as a database), a microservice for submission of new key/value packets, and a microservice for retrieval/query of the repository for data. The ingestor is a component which receives the raw data logs and ingests them into the UDM format. The ingestor is able to determine the vehicle model from the files being submitted, with the detection process/requirements varying based on vendor. The ingestor accepts robot model plugins, which will allow it to interpret/decode a given robot model's raw log format into UDM key/value pairs.

An App Layer Datastore provides an additional relational datastore with one or more of the following concepts: users/pilots; robots, batteries, components/parts; payloads; customers, jobs, etc.; flights/missions/etc. Any sensor data lives in a different datastore and is tied to a flight/operation that uses a particular unmanned vehicle and/or components that in turn define the sensor data that may be recorded.

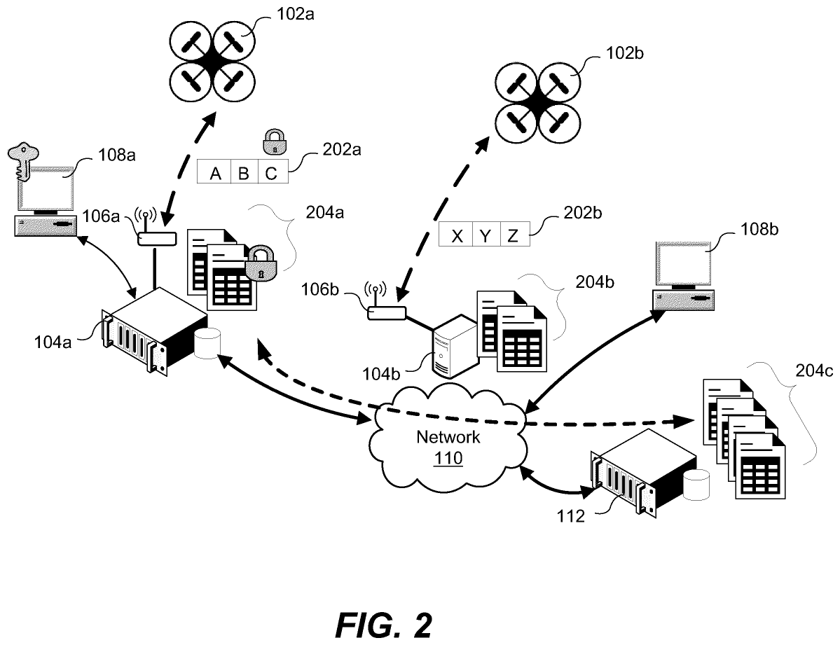

FIG. 2 shows a representation of a system used for generating reports for a fleet of unmanned vehicles. The system of FIG. 2 further highlights the security of sensitive data as described with reference to FIG. 1.

Data 202a from a customer's drone 102a is received at the server 104a on the Customer Network 150 through the wireless router 106a. As depicted, some of the data 202a received from the drone 102a may be sensitive and/or encrypted. As described with reference to FIG. 1 and will be further described herein, the sensitive elements of the data received from the drone 102a is stored within the Customer Network 150 at the server 104a, and non-sensitive data may be sent to the central server 112 through the Global Network 110 for storage in the Data Platform 120, and/or the non-sensitive data may also be stored within the Customer Network 150 at the server 104a.

Data 202b from a customer's drone 102b is received at the server 104b on the Customer Network 150 through the wireless router 106b. As depicted, all of the data 202b received from the done 102b is non-sensitive. As described with reference to FIG. 1 and will be further described herein, the non-sensitive may be sent to the central server 112 through the Global Network 110 for storage in the Data Platform 120, and/or the non-sensitive data may also be stored within the Customer Network 150 at the server 104a.

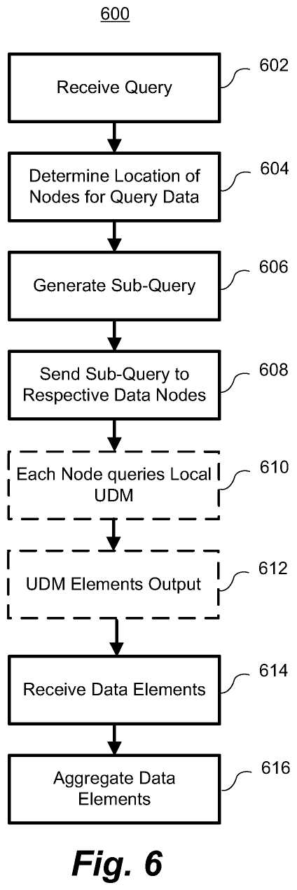

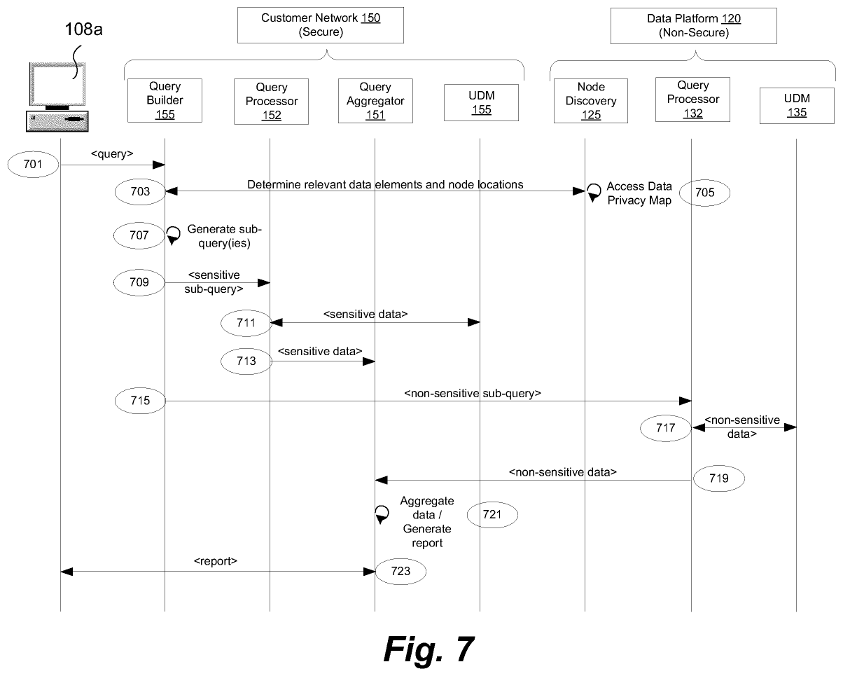

If a pilot/customer wishes to access data and/or perform data analytics, the pilot/customer is restricted based on the security levels and authorization requirements associated with the data. For example, if a user of computer 108a on the Customer Network 150 wishes to access data and/or perform data analytics, the user, in accordance with any additional security requirements, will have access to data and reports 204a containing both non-sensitive data from several pilots/customers (both internal and external to the Customer Network 150) and sensitive data particular to the pilot/customer that sends data to the Customer Network 150. If a user of computer 108b that connects to the central server 112 through the Global Network 110 wishes to access data and/or perform data analytics, that user only has access to data and reports 204b containing non-sensitive data from the various pilots/customers. A collection of reports 204c containing non-sensitive data may also be stored and accessible at the central server 112. A further description of the method for generating reports is provided in FIGS. 6 and 7.

It is noted that the systems depicted in FIGS. 1 and 2 are simplified for explanatory purposes, and in implementation the system may support several Customer Networks 150 each configured to receive data from one or more unmanned vehicles, and the data received at the server 104b on the Global Network 110 is similarly configured to receive data from one or more vehicles.

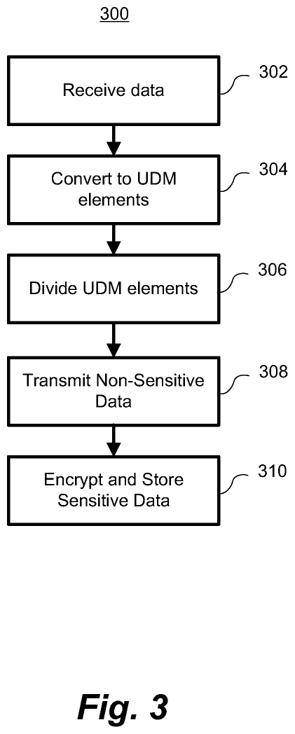

FIG. 3 shows a method for partitioning data received from one or more unmanned vehicles. The method 300 may be performed, for example, by the server located within the Customer Network 150.

Unmanned vehicle (UV) or industrial vehicle data is received at the server (302). The received UV data is raw data received from an UV owned/operated by an owner/user of a data node within the customer network. The raw UV data may comprise one or both of sensitive data and non-sensitive data. The raw data is converted to a plurality of universal data elements in accordance with the UDM (304). Each universal data element may, for example, indicate the UV from which the raw data was received, a sensor reading of the UV, and a time that the sensor reading occurred. The conversion of raw data to the universal data elements may be performed, for example, by the Ingestor within the Data Node and based on Model Schema for that UV or vehicle type.

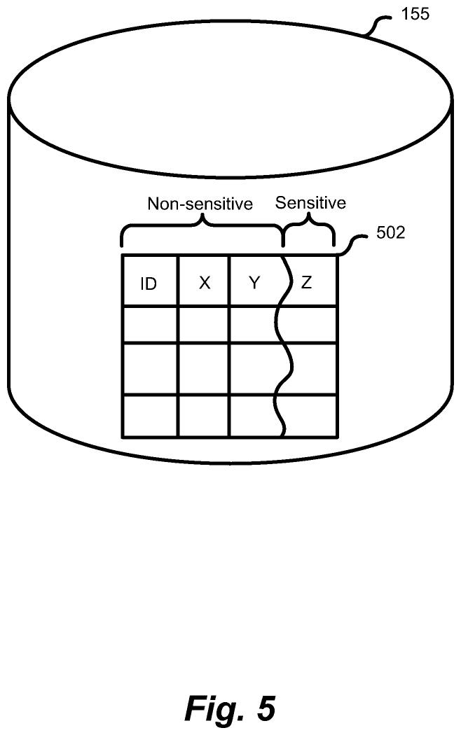

The universal data elements may be divided (306), for example into sensitive data and non-sensitive data. Other states may also be available, such as obfuscate, etc. Dividing the data into states may be performed by the Ingestor 154, for example by using the Node Discovery 125 and Data Privacy Map 142. The division of sensitive and non-sensitive data may be implemented in several ways without departing from the scope of this disclosure. For example, as will be described with reference to FIG. 5 below, both the non-sensitive data and sensitive data may be stored in the UDM 155 within the customer network, where the non-sensitive data and sensitive data may be divided based on their storage location within the UDM. In other embodiments, an index and/or label indicating the data sensitivity may be generated and associated with the data. Non-secure data is transmitted (308), for example to a Repository 133 in the Data Platform 120, to a Repository in a different Data Node, or to a Query Aggregator. The non-sensitive data may be transmitted while also storing the data in the UDM 155 of the Customer Network 150. The non-sensitive data may be transmitted and not stored in the UDM 155 of the Customer Network 150. The non-sensitive data may only be transmitted when requested, such as during a query building process as further described with reference to FIG. 6 below. The sensitive data is encrypted and securely stored (310) in the UDM 155 of the Customer Network 150.

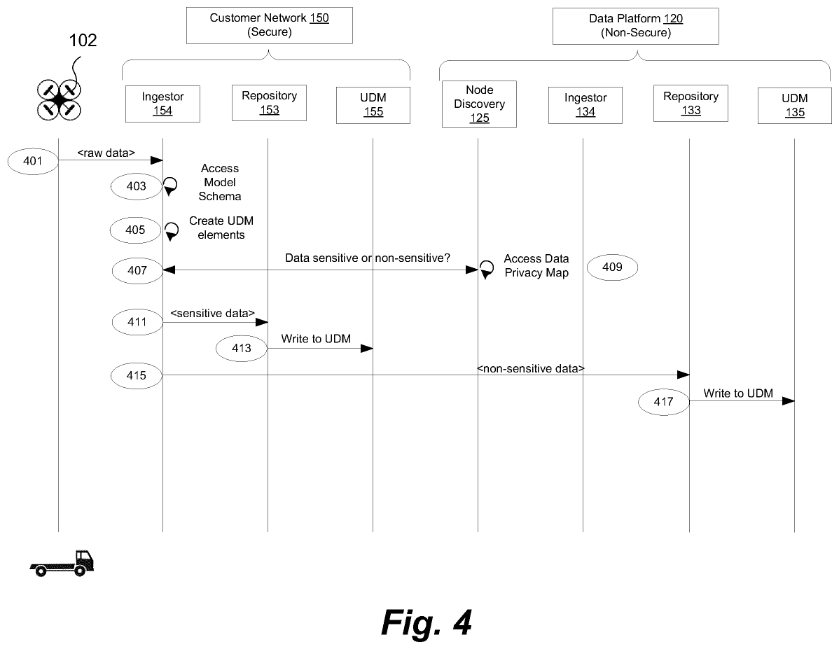

FIG. 4 shows a diagram representing the partitioning of data received from an unmanned vehicle or industrial vehicle. Raw data is received from the vehicle 102, for example a drone, at the Ingestor 154 of the Customer Network (401). The Ingestor accesses the Model Schema 141, 161 (403), and uses the mapping of the Model Schema to create UDM elements (405). The Model Schema may be particular to the type or model of UV or vehicle from which the raw data was received from, and the Ingestor may first need to identify or determine the type or model of the UV. The Ingestor determines if the data is sensitive or non-sensitive by communicating with the Node Discovery 125 (407). The Node Discovery determines how to divide the data by accessing a Data Privacy Map 142 (409).

Sensitive data is sent from the Ingestor 154 to a Repository 153 within the Customer Network (411), and the sensitive data is written from the Repository 153 to the UDM 155 within the Customer Network (413). The process of writing the sensitive data to the UDM within the Customer Network may comprise encrypting the sensitive data. The encryption of the sensitive data may be in accordance a security level required to access the data, which may be set forth in the Data Privacy Map 142. Non-sensitive data is sent from the Ingestor 154 to a non-secure Repository 133 (415), such as within the Data Platform 120, and the non-sensitive data is written by the non-secure Repository to the UDM 135 of the Data Platform 120 (417).

The diagram shown in FIG. 4 represents one possible embodiment for how the data is partitioned, and variations may exist without departing from the scope of this disclosure. For example, the locations of the metadata comprising the Model Schema and Data Privacy Map may be one or both of the Customer Network and the Data Platform. In another embodiment, the Customer Network may comprise a plurality of Data Nodes and a Node Discovery element may be located within the Customer Network. In yet another embodiment, as previously described, the non-sensitive data may alternatively or additionally be stored within the UDM of the Customer Network.

FIG. 5 shows a data storage structure for storing vehicle data. The data storage structure shown in FIG. 5 represents UDM 154 within the Customer Network 150. Shown within the UDM 155 is an exemplary data table 502. The data table 502 is divided into columns containing non-sensitive data and columns containing sensitive data. Each row in the data table 502 may correspond to a universal data element.

As previously described, each universal data element may indicate an identifier for the UV associated with the data element, a sensor reading from the UV, and a time that the sensor reading occurred. As depicted, the vehicle identifier may be considered non-sensitive information, or may be represented by a hash. The time at which a sensor reading occurs may also be considered non-sensitive information, and stored for example in column X. Depending on the type of sensor reading, the sensor reading may be considered non-sensitive information and stored for example in column Y, or may be considered sensitive information and stored for example in column Z.

As described above, the determination of whether or not data is sensitive can be based on a Data Privacy Map established by the owner/user of the vehicle and/or Data Node. For example, the Data Privacy Map may establish that a sensor reading corresponding to the speed of a drone, or a sensor reading corresponding to a voltage reading of a drone battery, may be non-sensitive data. On the other hand, the Data Privacy Map may establish that a sensor reading corresponding to the GPS of a drone, or a payload of the drone, may be sensitive data. In an example of data that is received from military drones, it may be undesirable for data indicating where the drone is flying, and data possibly indicative of weaponry the drone is equipped with, to be made available to the public and hence the GPS data and payload may be classified as sensitive data.

The data table 502 contains, as a whole, all universal data elements for a fleet of vehicles associated with the Customer Network. When transmitting data to the Data Platform or Query Aggregator of another Data Node, the data table 502 facilitates transmitting only the non-sensitive data according to the columns that are identified as storing non-sensitive data. For further security, the sensitive data may be encrypted when stored in the UDM 155 so that it cannot be accessed by unauthorized users. In comparison, the UDM 135 of the Data Platform 120 would contain only non-sensitive data.

The data table 502 is shown for exemplary purposes, and may be implemented in numerous ways without departing from the scope of this disclosure. As previously described, additional or alternative states for classifying data may be envisioned. For example, it may be desirable for the ID of the vehicle to be obfuscated. In this regard, an obscure ID may be transmitted, thus making it unidentifiable as to where the data came from (e.g., it cannot be determined that the data element is for a military drone), but the non-secure data can still be effectively analyzed (e.g., by examining several voltage readings taken for the battery of Drone1234, it may be determined that the battery-life of such drone type is worse than other models of drones, but the general identifier provides no indication that the drone is a military drone).

FIG. 6 shows a method for responding to a query that requests unmanned vehicle data. In some embodiments, the method 600 may be performed by the server 104a located within the Customer Network 150. In other embodiments, the method 600 may be performed by the server 106a providing the Data Platform 120. Querying the Data Platform may, for example, be performed by a recreational user who does not have their own Customer Network with a Data Node.

A query is received at the server (602). The query may originate, for example, from a user of a web or mobile application supported by the system, and is received at the Query Builder. The query may, for example, request analytics data, and the query may have a security level associated therewith. The security level may be determined from login credentials of the user, the location from which the query originated, etc. Based on the security level associated with the query and the analytics data requested by the query, the locations of nodes that have data relevant to the query and where the security level of the query complies with the security level and sensitivity of the data stored thereon is determined (604). This determination may be performed using Node Discovery and the Data Privacy Map for the respective nodes. If no data elements are available for responding to the query (for example, the security level associated with the query is below the security level of the data that is being queried), an error is returned.

A sub-query is generated for the determined nodes (606) that requests the data elements relevant for the query. The sub-queries also indicate a Query Aggregator to which the data elements should be sent to. The specified Query Aggregator is generally located within the Data Node from which the query was received/originated, but does not have to be limited to such. These sub-queries are sent to the respective nodes (608) determined to contain data relevant to the query, with the sub-queries being sent from the Query Builder to respective Query Processors.

Depending on the query and the locations of the nodes having data elements relevant to the query, the number of sub-queries and the locations of nodes that the sub-queries are sent to may greatly vary. For example, military personnel with a high level of security clearance may query for sensitive data from their fleet of UVs. The query would be received at the server on the Customer Network and, determining that the relevant data is only stored in the UDM on the Customer Network and that the security level associated with the query is compliant with the sensitivity of the data being requested, the sub-query may only be sent to the Query Processor at the Data Node in the Customer Network.

In another example, the same military personnel may wish to assess non-sensitive data, such as in order to determine what model of drone has the longest flying range before needing to be recharged. The query would be received at the server on the Customer Network and the Query Builder determines all of the nodes that have data relevant to the query. If all non-sensitive data is pushed to the Data Platform, the sub-query might only be sent to the Query Processor in the Data Platform. If some nodes have relevant non-sensitive data stored in the local UDM, the sub-query may also be generated and sent to Query Processors on different networks.

The Query Processor receives a sub-query, and the local UDM is queried for the relevant data elements (610). If a sub-query is received for data elements that the local UDM does not possess, the Query Processor returns an error. The data elements are output (612) from the respective Query Processors to the Query Aggregator that was identified in the sub-query. The Query Aggregator receives (614) and aggregates (616) the data elements. The data elements may be aggregated into a report that facilitates analysis of the retrieved data. The user from which the query first originated may be provided with a location of the Query Aggregator from which to view the aggregated data/report.

FIG. 7 shows a diagram representing the generation of a report in response to a query. The diagram in FIG. 7 is representative of one scenario for a query requesting both non-sensitive and sensitive data, and where the user is an authorized user (i.e., a user that has a security level appropriate to access the sensitive data). However, as described with reference to FIG. 6, various types of queries may exist and various implementations for storing the data may exist, and therefore the diagram shown in FIG. 7 represents only one embodiment and variations of such may be implemented without departing from the scope of this disclosure.

A query is received at the Query Builder 155 (701). Note that the Query Builder 155 is not shown in FIG. 1, however as previously noted several logical elements that are in the Data Platform 120 may similarly be located within the Customer Network 150, allowing for various implementations of the system to be possible without affecting the functionality of the system. The Query Builder 155 determines data elements that are relevant to the query and the locations of nodes where the relevant data elements are stored based on the Node Discovery 125 (703). The Node Discovery 125 may access the Data Privacy Map 142 (705) to determine the sensitivity of data elements for different customers, thereby identifying the non-sensitive data elements of those customers that may be relevant to the query and retrieved. Based on the determination of node locations where the relevant data elements are stored, the Query Builder 155 generates a sub-query or sub-queries (707). In the example of this diagram, all of the sensitive data to be retrieved is stored in a single UDM 155 within the Customer Network 150, and all of the non-sensitive data to be retrieved is stored in the UDM 135 of the Data Platform 120.

The sub-query for sensitive data is sent from the Query Builder 155 to the Query Processor 152 on the secure Customer Network 150 (709). The Query Processor 152 queries the relevant sensitive data elements from the local UDM 155 and retrieves the data elements (711). The sensitive data elements are sent from the Query Processor 152 to the Query Aggregator 151 (713).

The sub-query for non-sensitive data is sent from the Query Builder 155 to the Query Processor 132 on the non-secure Data Platform 120 (715). The Query Processor 132 on the Data Platform 120 queries the relevant non-sensitive data elements from the UDM 135 of the Data Platform 120 and retrieves the data elements (717). The non-sensitive data elements are sent from the Query Processor 132 to the Query Aggregator 151 (719).

Having received the data elements, the Query Aggregator 151 aggregates the data and generates a report in response to the query (721). The report is accessed by/sent to the user from which the query originated (723).

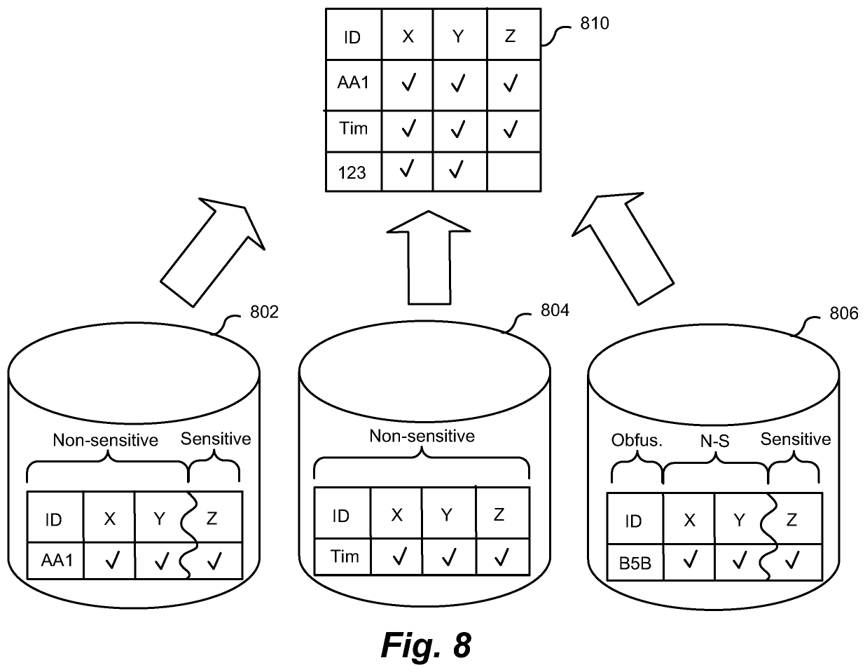

FIG. 8 shows a diagram representing the aggregation of unmanned vehicle data. Continuing with the exemplary query received in FIG. 7 (i.e. a query requesting both non-sensitive and sensitive data, and where the user is an authorized user), the UDM 802 corresponds to a UDM on the Customer Network from which the query was received, and the UDM 804 corresponds to the UDM on the Data Platform. For exemplary purposes, further consider that there is data relevant to the query and which is stored in a UDM 806 of a Data Node on a separate Customer Network. In accordance with the security restrictions established by the customers/owners through their Data Privacy Map, a report 810 is generated in response to the query.

The relevant data element within the UDM 802 contains both sensitive and non-sensitive information, all of which is provided in the report 810 because the user from which the query originated has access/security clearance to view the sensitive data.

The relevant data element within the UDM 804 only contains non-sensitive information. The unmanned vehicle data is identified as belonging to “Tim”, and Tim does not mind sharing all of his UV data, nor having his data being identifiable as belonging to him, so Tim uploads all of his data to the Data Platform and places no restrictions on what may be shared in analytics reports. All of the data within the data element from the UDM 804 is provided in the report 810.

The relevant data element within the UDM 806 contains non-sensitive information, sensitive information, and information which is designated to be obfuscated. In this case, the identifier indicating the vehicle associated with the data element is designated to be obfuscated. Perhaps the vehicle belongs to a corporation which is concerned that the identifier of their unmanned vehicles may be identifiable as belonging to them, and the corporation does not wish to make public how many drones are in their fleet, for example. The identifier is not obfuscated in the UDM 806, because an employee at the corporation may wish to access the UDM and uniquely identify the different vehicles. However, when the data is provided in the report 810, the identifier has been obfuscated and now is output as “123”. The non-sensitive data from the data element in UDM 806 is also provided in the report, however no sensitive data is provided from the UDM 806.

Although certain components and steps have been described, it is contemplated that individually described components, as well as steps, may be combined together into fewer components or steps or the steps may be performed sequentially, non-sequentially or concurrently. Further, although described above as occurring in a particular order, one of ordinary skill in the art having regard to the current teachings will appreciate that the particular order of certain steps relative to other steps may be changed. Similarly, individual components or steps may be provided by a plurality of components or steps. One of ordinary skill in the art having regard to the current teachings will appreciate that the system and method described herein may be provided by various combinations of software, firmware and/or hardware, other than the specific implementations described herein as illustrative examples.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Each element in the embodiments of the present disclosure may be implemented as hardware, software/program, or any combination thereof. Software codes, either in its entirety or a part thereof, may be stored in a computer readable medium or memory (e.g., as a ROM, for example a non-volatile memory such as flash memory, CD ROM, DVD ROM, Blu-ray™, a semiconductor ROM, USB, or a magnetic recording medium, for example a hard disk). The program may be in the form of source code, object code, a code intermediate source and object code such as partially compiled form, or in any other form.

It would be appreciated by one of ordinary skill in the art that the system and components shown in FIGS. 1-8 may include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

1. A method of partitioning data received from one or more vehicles, comprising:
receiving vehicle raw data from an vehicle of the one or more vehicles, the vehicle raw data comprising both sensitive and non-sensitive data;
converting the vehicle raw data into a plurality of universal data elements, each data element indicating the vehicle from which the raw data was received, a sensor reading of the vehicle, and a time that the sensor reading occurred;
determining, from a data privacy map established by an owner of the vehicle, which of the universal data elements are sensitive data elements and which of the universal data elements are non-sensitive data elements;
transmitting the non-sensitive data elements to an external device; and
storing the sensitive data elements locally.

2. The method of claim 1, wherein the data privacy map further indicates which of the universal data elements are to be obfuscated, the method further comprising:
storing the universal data elements that are indicated to be obfuscated locally;
obfuscating the universal data elements that are indicated to be obfuscated; and
transmitting the obfuscated data elements to the external device.

3. The method of claim 1 or 2, wherein converting the vehicle raw data into a plurality of universal data elements comprises:
identifying a model of the vehicle from which the vehicle raw data was received;
accessing a pre-determined mapping particular to the model of the vehicle, the mapping indicating how to convert the vehicle raw data for the model of the vehicle to the plurality of universal data elements.

4. The method of claim 3, wherein the universal data elements have the same format for all models of the vehicle.

5. The method of any one of claims 1 to 4, further comprising storing the non-sensitive data elements locally.

6. The method of claim 5, wherein the non-sensitive data elements are transmitted to the external device in response to a query from the external device.

7. The method of any one of claims 1 to 6, further comprising transmitting the sensitive data elements to a device within a local network.

8. The method of any one of claims 1 to 7, wherein the data privacy map further indicates a security level required to access the sensitive data.

9. The method of any one of claims 1 to 8, wherein the vehicle raw data received from the vehicle is encrypted, and the method further comprises decrypting the vehicle raw data.

10. The method of any one of claims 1 to 9, wherein storing the sensitive data elements locally comprises encrypting the sensitive data elements.

11. The method of any one of claims 1 to 10, wherein the vehicle is an unmanned aerial vehicle.

12. The method of any one of claims 1 to 10, wherein the vehicle is an industrial vehicle.

13. A method of responding to a query requesting vehicle data, comprising:
receiving, from a user, the query requesting vehicle data, the query having a security level associated therewith;
determining, based on the security level associated with the query and the vehicle data requested by the query, vehicle data elements that provide the vehicle data requested and that correspond to the security level associated with the query;
determining one or more nodes storing the vehicle data elements;
generating a sub-query request for each of the one or more nodes, the sub-query request indicating the vehicle data elements to be retrieved at the respective node, and an indication of an output node to which the vehicle data elements should be sent to;
sending the sub-query requests to each of the one or more nodes;
receiving the requested vehicle data elements from the one or more nodes; and
aggregating the vehicle data elements to provide a report.

14. The method of claim 13, wherein the vehicle data requested by the query is one or both of sensitive and non-sensitive.

15. The method of claims 13 to 14, wherein a sub-query for the sensitive vehicle data is sent to a node on a local network.

16. The method of any one of claims 13 to 15, wherein a sub-query for the non-sensitive vehicle data is sent to one or both of a node on a local network and a node on an external network.

17. The method of any one of claims 13 to 16, further comprising:
querying a local data storage for the requested vehicle data elements comprising one or both of the sensitive data and the non-sensitive data; and
outputting the vehicle data to the output node.

18. The method of any one of claims 13 to 17, wherein the security level is based on log-in credentials of the user.

19. The method of any one of claims 13 to 18, further comprising:
receiving an error from a node of the one or more nodes in response to the sub-query when the data requested from the node is not available.

20. The method of any one of claims 13 to 19, further comprising:
returning an error when there are no vehicle data elements on any node that provide the vehicle data requested and that correspond to the security level associated with the query.

21. The method of any one of claims 13 to 20, wherein the query is received through a user interface of a supported application.

22. The method of claim 21, wherein the report is presented in the user interface.

23. The method of any one of claims 13 to 22, further comprising:
storing the report locally at the output node; and
notifying the user of the output node for which an aggregation of the vehicle data elements is stored.

24. The method of any one of claims 13 to 23, wherein the vehicle is an unmanned aerial vehicle.

25. The method of any one of claims 13 to 24, wherein the vehicle is an industrial vehicle.

26. A system for partitioning data received from one or more vehicles and responding to a query requesting vehicle data, comprising:
a first server hosting a customer network; and
a second server hosting a cloud-based data platform operably coupled with the first server through a data network;
wherein the first server is configured to:
receive vehicle raw data from an vehicle of the one or more vehicles that is operably coupled with the customer network, the vehicle raw data comprising both sensitive and non-sensitive data;
convert the vehicle raw data into a plurality of universal data elements, each data element indicating the vehicle from which the raw data was received, a sensor reading of the vehicle, and a time that the sensor reading occurred;
determine, from a data privacy map established by an owner of the vehicle, which of the universal data elements are sensitive data elements and which of the universal data elements are non-sensitive data elements;
transmit the non-sensitive data elements to the second server through the data network; and
store the sensitive data elements locally.

27. The system of claim 26, wherein the second server is configured to:
receive the non-sensitive data elements from the first server; and
store the non-sensitive data elements locally.

28. The system of claim 27, wherein the second server is configured to:
receive vehicle raw data from an vehicle of the one or more vehicles that is not connected to the customer network, the vehicle raw data comprising only non-sensitive data;
convert the vehicle raw data into a plurality of universal data elements, each data element indicating the vehicle from which the raw data was received, a sensor reading of the vehicle, and a time that the sensor reading occurred; and
store the non-sensitive data elements locally.

29. The system of claim 27, wherein the first server is further configured to:
receive a query from a user of a device on the customer network requesting vehicle data, the query having a security level associated therewith;
determine, based on the security level associated with the query and the vehicle data requested by the query, vehicle data elements that provide the vehicle data requested and that correspond to the security level associated with the query;
generate a sub-query request for each of the one or more nodes, the sub-query request indicating the vehicle data elements to be retrieved at the respective node, and an indication of an output node to which the vehicle data elements should be sent to;
send the sub-query requests to each of the one or more nodes;
receive the requested vehicle data elements from the one or more nodes; and
aggregate the vehicle data elements to provide a report.

30. The system of claim 26, wherein the vehicle data requested by the query is one or both of sensitive and non-sensitive, and wherein the first server is further configured to:
send a sub-query request for sensitive vehicle data to a node within the customer network; and
send a sub-query request for non-sensitive vehicle data to a node external to the customer network,
wherein the node external to the customer network is either located within the data platform hosted by the second server or is located within a separate customer network.

31. The system of claim 26, wherein the second server is further configured to:
receive a query from a user of a device on the data network requesting vehicle data;
determine, based on the vehicle data requested by the query, vehicle data elements that provide the vehicle data requested and that correspond to the security level associated with the query;
generate a sub-query request for each of the one or more nodes, the sub-query request indicating the vehicle data elements to be retrieved at the respective node, and an indication of an output node to which the vehicle data elements should be sent to;
send the sub-query requests to each of the one or more nodes;
receive the requested vehicle data elements from the one or more nodes; and
aggregate the vehicle data elements to provide a report.

32. The system of claim 31, wherein the vehicle data requested by the query is non-sensitive and wherein there is no security level associated with the query, and wherein the second server is further configured to:
send a sub-query request for non-sensitive vehicle data to one or both of a node within the customer network and a node within the data platform.

33. The system of any one of claims 26 to 32, wherein the vehicle is an unmanned aerial vehicle.

34. The system of any one of claims 26 to 32, wherein the vehicle is an industrial vehicle.
